(19) United States
(12) Patent Application Publication
(10) Pub. No.: US 2025/0379412 A1
(43) Pub. Date: Dec. 11, 2025

(54) Light Source

(71) Applicant: Nippon Telegraph and Telephone Corporation, Tokyo (JP)

(72) Inventor: Shigeo Ishibashi, Musashino-shi, Tokyo (JP)

(21) Appl. No.: 18/874,053

(22) PCT Filed: Jun. 16, 2022
(86) PCT No.: PCT/JP2022/024174

§ 371 Date: Dec. 11, 2024

(51) Int. Cl. H01S 3/1112; G01J 3/10; G01J 3/44; H01S 3/067; H01S 3/108; H01S 3/30

(52) U.S. Cl. CPC H01S 3/1112; G01J 3/10; H01S 3/06716; H01S 3/108; H01S 3/302; G01J 3/4412

(57) ABSTRACT

A light source includes a mode-locked laser; a beam splitter that branches the femtosecond optical pulse train; a CW solid-state laser; a first beam combiner that outputs one side of the femtosecond optical pulse train on the same axis; a secondary nonlinear optical element that outputs a difference frequency generation and conversion optical pulse train from either a continuous wave or a femtosecond optical pulse train; an amplifier that amplifies the difference frequency generation and conversion optical pulse train; a polarization-maintaining all normal dispersion high nonlinear fiber that converts the other femtosecond optical pulse train into a supercontinuum optical pulse train; a first dispersion medium that converts the supercontinuum optical pulse train into a pulse width that is approximately the same as the difference frequency generation and conversion optical pulse train; and a second beam combiner that multiplexes and outputs the difference frequency generation and conversion optical pulse train and the supercontinuum optical pulse train.

### TECHNICAL FIELD

The present disclosure relates to a light source, and more particularly, to a light source for analysis and observation by Raman scattering spectroscopy for detecting a second harmonic generation, a third harmonic generation and coherent anti-Stokes Raman scattering.

### BACKGROUND ART

Raman scattering spectroscopy is widely used in many scientific fields such as chemistry, biology, medicine, pharmaceuticals, agriculture, and physics, as a means for obtaining vibrational information from molecules, crystals, and amorphous structures, and is widely put into practical use in medical care and industrial applications. Classical Raman scattering spectroscopy applies spontaneous Raman scattering. Spontaneous Raman scattering is a phenomenon in which scattered light having a frequency shifted by a frequency of molecular vibration or lattice vibration is generated with respect to incident light. Since the scattered light has a very weak power compared with the power of the original incident light, a light source of the incident light having a high power is required to obtain scattered light measurable by the detector. However, most of the measurement samples have an upper limit of power per unit area with which they may be irradiated, and if the power exceeds the upper limit, they are altered or destroyed. In many cases, even if a light source having a power corresponding to the upper limit is used, the scattered light is weak, and to obtain a signal having a high S/N ratio, a very long measurement time is required. On the other hand, since coherent anti-Stokes Raman scattering (hereinafter referred to as “CARS”) is a nonlinear optical process with a light source having a high instantaneous power, when a light source having a power equal to that of spontaneous Raman scattering is used, the power of the Raman scattered light is significantly strong, and as a result, measurement in a short time becomes possible.

The development of CARS measurement accompanying the development of a pulse laser as a light source is significant, and in particular, when a microscopic image is acquired, the effects thereof are significant. When a pulse laser having a high instantaneous power is used as the light source, not only CARS but also second harmonic generation (hereinafter referred to as SHG) and third harmonic generation (hereinafter referred to as THG) can be detected simultaneously. A microscope having such a configuration is called a multi-modal nonlinear optical microscope, and many applications have been proposed therefor in life sciences, medicine and pharmaceuticals, and further development thereof is desired in the future (e.g., see NPL 1).

In the case where organisms and biological substances are to be measured by Raman scattering spectroscopy, there are two important wavenumber regions, one of which is a region of a wavenumber of 500 cm⁻¹ to 1800 cm⁻¹ called a fingerprint region, and the other is a region of a wavenumber of 2800 cm⁻¹ to 4000 cm⁻¹ due to a carbon-hydrogen (C—H) bond, a nitrogen-hydrogen (N—H) bond or an oxygen-hydrogen (O—H) bond (e.g., see, NPLs 1 and 13). In the case of measuring using CARS spectroscopy, light beams of two wavelengths having a difference in wavenumber corresponding to the wavenumber of the region (the difference in the wavenumber of the two lights is the wavenumber corresponding to the wavenumber of the region) are made incident on an object to be measured (sample).

FIG. 1 is a diagram conceptually showing a structure of a CARS light source 10 according to the related art. As shown in FIG. 1, the CARS light source 10 according to the related art includes a pump light/probe light source 11, a Stokes light source 12, an electrical signal path 13 that electrically connects the pump light/probe light source 11 and the Stokes light source 12 and synchronizes the pulse timing, and a beam combiner 14 that multiplexes the lasers output from the pump light/probe light source 11 and the Stokes light source 12 (see, for example, NPL 2). As an example, the pump light/probe light source 11 is a Ti-sapphire laser, and outputs a picosecond pulse train that has a of 0.73 μm, a pulse band of 0.11 nm, a pulse width of 5 ps, and a repetition frequency of 80 MHz. On the other hand, the Stokes light source 12 is also a Ti-sapphire laser, and outputs a femtosecond optical pulse train that has a center of 0.80 μm, a pulse band of 80 nm, a pulse width of 12 fs, and a repetition frequency of 80 MHz. These two systems of optical pulse trains are multiplexed by the beam combiner 14 and input to the microscope 15 through the same optical path. The two systems of optical pulses are simultaneously radiated to the sample, thereby obtaining a CARS signal from the sample. Here, the pulse width of the Stokes light expands to 1.54 ps due to optical dispersion in the optical path reaching the sample surface.

FIG. 2 is a diagram showing an energy diagram of molecules of a sample measured using CARS spectroscopy. As shown in FIG. 2, with measurement in CARS spectroscopy, by making pump light (angular frequency ω₁), Stokes light (angular frequency ω₂), and probe light (angular frequency ω₃) incident, a CARS light (angular frequency ω_{CARS}) corresponding to the angular frequency Ω of the vibration mode of the molecule of the sample is generated. An example of the related art shown in FIG. 1 is a form in which the same picosecond pulse train is used as the pump light and probe light (i.e., ω₁=ω₃), and a broad band femtosecond optical pulse train is used as the Stokes light. Thus, a number of vibration modes are excited and broad band CARS light can be measured, and such spectroscopy is called a multiplex CARS process (e.g., see NPL 3).

Here, a relationship between an average power of the incident light input from the light source and the signal intensity of the CARS signal is described. The intensity of light per unit area at time t and position xᵢ (i=1, 2 or 3) of a light pulse of angular frequency ω is set as I_{ω}(t, xᵢ) (W/m²). In addition, the peak intensity I_{ω·0} (W/m²), the pulse width τ(s), the repetition frequency fᵣₑₚ (Hz), the average power P_{ω·av} (W), and the oscillation λ(μm) (λ=2πcω⁻¹, c: speed of light) are set, and a duty ratio D is defined by (Equation 1).

$$\begin{matrix}[ Math . 1 ] & \\ D = τ {f}_{rep} & ( Equation 1 )\end{matrix}$$

Further, a beam focal area A is proportional to a square of the λ if it is set to a minimum possible value, and therefore can be expressed by the following (Equation 2).

$$\begin{matrix}[ Math . 2 ] & \\ A ∝ {λ}^{2} & ( Equation 2 )\end{matrix}$$

As a result, the average power Poav of the incident light satisfies the proportional relationship represented by Equation 3.

$$\begin{matrix}[ Math . 3 ] & \\ {P}_{ω \cdot av} = {\int }_{pulse} {I}_{ω} ( t , {x}_{i} ) {dtdx}_{i} \cdot {f}_{rep} ∝ {I}_{ω \cdot 0} A τ {f}_{rep} = {I}_{ω \cdot 0} AD & ( Equation 3 )\end{matrix}$$

Further, the power P_{CARS·av} of the CARS signal is proportional to the product of five elements of the peak intensity of each of the pump light, probe light, and Stokes light, the beam focal area of the CARS light, and a minimum duty ratio of each duty ratio of the pump light, probe light, and Stokes light. Assuming that the wavelengths of the pump light and the probe light are λ₁ and the of the Stokes light is λ₃, the beam focal area of the CARS light is generally proportional to the square of λ₁. Accordingly, the following Equation (4) is established from these.

$$\begin{matrix}[ Math . 4 ] & \\ {P}_{CARS \cdot av} ∝ {{P}_{ω1 \cdot av}}^{2} {P}_{ω3 \cdot av} {{λ}_{1}}^{- 2} {{λ}_{3}}^{- 2} {D}^{- 2} & ( Equation 4 )\end{matrix}$$

That is, the power of the CARS signal obtained by the CARS measurement depends on the average power, and duty ratio of each incident light (pump light, Stokes light, etc.).

In the case of observing a biological tissue using the CARS measurement, it is important to select a condition for not damaging a tissue to be a sample. According to the existing report, it has been shown that there are two mechanisms of a linear response to the power of the incident light and a higher-order response when the biological tissue is damaged by the incident light (see, for example, NPL 4). For the linear response mechanism, it is necessary to set the upper limit of the total incident power to avoid damage caused by the linear response mechanism. In this case, it can be seen from (Equation 4) that it is effective to reduce the duty ratio D to obtain a high CARS signal. However, reduction of D while keeping the total incident power constant leads to an increase in pulse peak power, and therefore there is a concern about damage due to a mechanism showing a higher-order response. According to existing reports, the optimum repetition frequency for a pulse width of 2.5 ps is 1 to 4 MHz (see, for example, NPL 4). Accordingly, as in the related art shown in FIG. 1, when using a typical solid mode synchronous laser with a repetition frequency of 80 MHz, a contrivance is required, and as one of such measures, a method of using line illumination has been introduced (e.g., see NPL 5).

FIG. 3 is a diagram conceptually showing the principle of the CARS microscope using the line illumination, FIG. 3 (a) is a diagram showing information allocation on a spectroscope CCD surface in the CARS microscope, and FIG. 3 (b) is a diagram showing the elliptical focus and a scanning direction thereof in the CARS microscope. In the method of using the line illumination described above, the optical system is set so that one axis of the two-dimensional CCD 31 attached to the spectroscope of the microscope shown in FIG. 3 (a) becomes a Y-axis position on the line and the other axis becomes a spectrum. Then, the laser beam as the incident light is scanned at a high speed on one line of the target sample, thereby substantially reducing the pulse repeation rate per pixel. The X-axis and the Z-axis sweep are performed by moving the sample using a piezo-stage. In this case, the laser power is increased compared to the point sweep to maintain the average power per pixel, but there is a risk of damage due to higher-order responses. In the privious reports, it has been stated that it is necessary to set the pulse peak intensity to 20 GW/cm² or less (e.g., see, NPL 2). Therefore, in the CARS microscope using the line illumination, as shown in FIG. 3 (b), there is a method in which the shape of the beam 32 at the focal point is set to an ellipse so that the focal point does not exceed this value.

However, since the damage threshold by linear absorption and the damage threshold by higher-order response differ depending on the type of biological tissue, in some cases, there is a problem that the peak intensity decreases more than necessary and the efficiency of CARS generation may become insufficient.

Furthermore, since the wavelengths used for pump light, probe light and Stokes light are limited to the oscillation of the Ti sapphire laser, the band of measurable Raman scattering may be limited to 1250 cm⁻¹ (see, for example, NPL 2). In the case of measuring organisms and biological substances, a measurement band of about 400 to 4000 cm⁻¹ is practically desired. Therefore, there is known a technique for measuring a wide band of Raman scattering by using supercontinuum light as Stokes light (see, for example, NPLs 1, 3 and 13). In these CARS microscopes of the related art, supercontinuum light generated by a high nonlinear fiber having anomalous dispersion is used. Although this generation method has a merit in that the generation band is wide, it is known that the spectrum shape for each pulse is greatly different and the S/N ratio is low (see, for example, NPL 12). As a method for improving this, it is known that supercontinuum light having a small difference between pulses and a high SN ratio can be obtained by making an ideal pulse (having no pedestal component of low power or no sub-peak before and after the pulse) of 100 fs or less incident on a polarization-maintaining all normal dispersion high nonlinear (hereinafter referred to as PM-AND-HNL) fiber (see, for example), NPLs 10, 11, and 12). The supercontinuum light obtained by using such a PM-AND-HNL fiber has a problem of a relatively narrow band (see, for example, NPL 11). In the existing reports, although supercontinuum light with the longest of 1.39 μm is generated by pump light with a of 1.049 μm (see, for example, NPL 10), if this is used in a CARS microscope, only Raman scattering up to 2300 cm⁻¹ can be measured. Therefore, a light source configuration is required which enables stable measurement up to about 4000 cm⁻¹ by the supercontinuum light obtained by using the PM-AND-HNL fiber.

### CITATION LIST

### Non Patent Literature

[NPL 1] Hiroaki Yoneyama et al., “Invited Article: CARS molecular fingerprinting using sub-100-ps microchip laser source with fiber amplifier”, APL Photonics 3, 092408 (2018)

[NPL 2] Shun Kizawa et al., “Ultrahigh-speed multiplex coherent anti-Stokes Raman scattering microspectroscopy using scanning elliptical focal spot”, J. Chem. Phys., 155, 144201 (2021)

[NPL 3] Hideaki Kano, “Nonlinear optical imaging using supercontinuum light”, Applied Physics, Vol. 86, No. 3, pp. 186 to 193, (2017)

[NPL 4] Y. Fu et al. “Characterization of photodamage in coherent anti-Stokes Raman scattering microscopy”, Opt. Express 14, 3942 to 3951 (2006).

[NPL 5] Ian Seungwan Ryu, et al., “Beam scanning for rapid coherent Raman hyperspectral imaging,” Opt. Lett. 40, 5826 to 5829 (2015)

[NPL 6] Z. Zhang et al., “Self-starting mode-locked Cr⁴⁺: YAG laser with a low-loss broadband semiconductor saturable-absorber mirror”, Opt. Lett., Vol.24, No.23, pp.1768 to 1770,(1999)

[NPL 7] Shota Nuki, “Precise measurement of refractive index of new lasers and nonlinear optical materials”, Master's thesis abstract, Department of Electrical, Electronic, Information and Communication Engineering, Faculty of Science and Technology, Chuo University (2013)

[NPL 8] E. Sidick et al., “Ultrashort-pulse second-harmonic generation. I. Transform-limited fundamental pulses”, J. Opt. Soc. Am. B, Vol. 12, pp.1704 to 1712 (1995)

[NPL 9] Osamu Tadanaga et al., “Highly efficient mid-infrared difference frequency generation using quasi-phase matching LiNbO3 ridge waveguide”, Laser Research, Vol. 36, No. 2,pp. 64 to 69, (2008)

[NPL 10] Etienne Genier et al., “Ultra-flat, low-noise, and linearly polarized fiber supercontinuum source covering 670-1390 nm”, Opt. Lett. 46, 1820-1823 (2021)

[NPL 11] Thibaut Sylvestre et al., “Recent advances in supercontinuum generation in specialty optical fibers.”, J. Opt. Soc. Am. B, Vol. 38, F90 to F103 (2021).

[NPL 12] Mariusz Klimczak et al., “Direct comparison of shot-to-shot noise performance of all normal dispersion and anomalous dispersion super continuum pumped with sub-picosecond pulse fiber-based laser.” Sci. Rep. 6, 19284 (2016).

[NPL 13] Daiki Kaneta et al., “Visualization of water concentration distribution in human skin by ultra-multiplex coherent anti-Stokes Raman scattering (CARS) microscopy”, Appl. Phys. Express 14, 042010 (2021).

### SUMMARY OF INVENTION

The present disclosure has been made in view of the above-mentioned problems, and an object of the present disclosure is to provide a light source for realizing analysis and observation (especially observation using a CARS microscope) using Raman scattering spectroscopy with high robustness for various types of samples (particularly biological tissue samples).

To the above-described problem, the present disclosure provides a light source for Raman scattering spectroscopy which includes a mode-locked laser that outputs a femtosecond optical pulse train of a center λₛ; a beam splitter that branches the femtosecond optical pulse train into two systems of a first femtosecond optical pulse train and a second femtosecond optical pulse train, in terms of power; a continuous wave oscillation solid-state laser that outputs continuous wave; a first beam combiner that transmits the continuous wave output from the continuous wave oscillation solid-state laser, reflects the first femtosecond optical pulse train, and outputs the continuous wave and the first femtosecond optical pulse train on the same axis; a secondary nonlinear optical element that includes at least one conversion element for outputting a difference frequency generation and conversion optical pulse train including picosecond optical pulses of a center λ_{c}, by generating a difference frequency between the continuous wave and the first femtosecond optical pulse train; an amplifier that amplifies the difference frequency generation and conversion optical pulse train; a polarization-maintaining all normal dispersion high nonlinear fiber that converts the second femtosecond optical pulse train into a supercontinuum optical pulse train; a first dispersion medium that converts the supercontinuum light pulse train into a pulse width which is approximately the same as a pulse width of the difference frequency generation and conversion optical pulse train output from the amplifier; and a second beam combiner which multiplexes and outputs the difference frequency generation and conversion optical pulse train output from the amplifier and the supercontinuum optical pulse train output from the first dispersion medium, in which a center λₛ and a center λ_{c} are set so that coherent anti-Stokes Raman scattering measurement is performed by the difference frequency generation and conversion optical pulse train and the supercontinuum optical pulse train output from the amplifier.

### BRIEF DESCRIPTION OF DRAWINGS

FIG. 1 is a diagram conceptually showing a structure of a CARS light source 10 according to the related art.

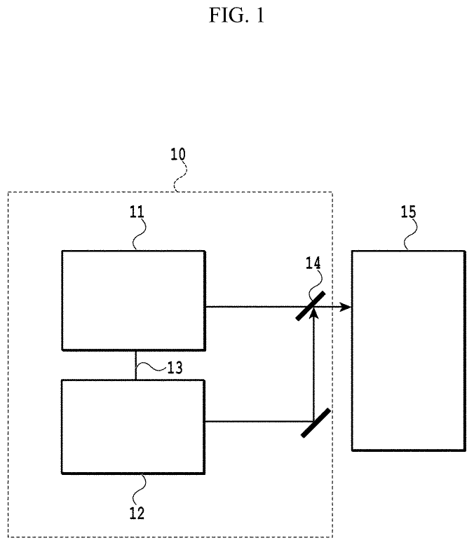

FIG. 2 is a diagram showing an energy diagram of molecules of a sample when measuring CARS spectroscopy.

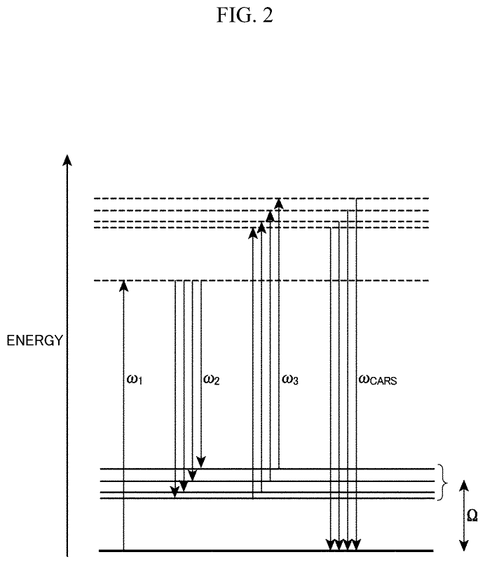

FIG. 3 is a diagram conceptually showing the principle of a CARS microscope using a line illumination, FIG. 3 (a) is a diagram showing information assignment on a spectrometer CCD surface in the CARS microscope, and FIG. 3 (b) is a diagram showing an elliptical focus and a scanning direction thereof in the CARS microscope.

FIG. 4 is a diagram conceptually showing the structure of a light source 40 according to the present disclosure, FIG. 4 (a) shows a form in which input light propagates through a conversion element 451b in a secondary nonlinear optical element 45, and FIG. 4 (b) shows a form in which input light propagates through a conversion element 451a in the secondary nonlinear optical element 45.

### DESCRIPTION OF EMBODIMENTS

Various embodiments of the present disclosure are described in detail below with reference to the accompanying drawings. The same or similar reference numerals indicate the same or similar elements and repeated description thereof may be omitted. Materials and numerical values are intended for illustration and are not intended to limit the technical scope of the present disclosure. The following description is an example, and some configurations may be omitted or modified, or may be implemented with additional configurations, unless it departs from the gist of one embodiment of the present disclosure.

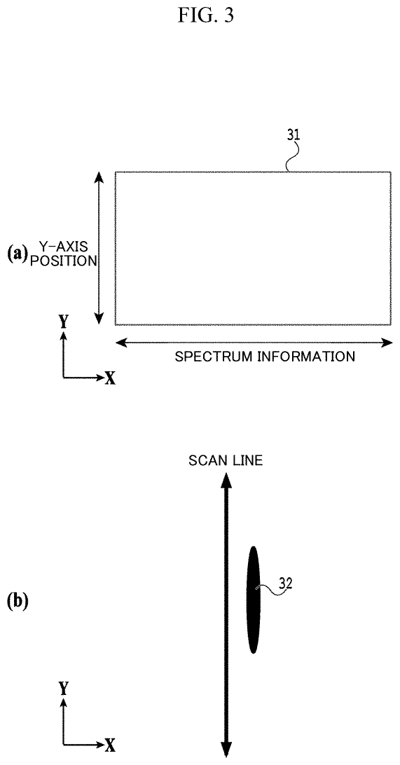

The light source according to the present disclosure focuses on a CARS light source using line illumination as shown in FIG. 3, and the use of line illumination itself is a known technology as described above. However, the present invention is different from the related art in that the pulse widths of the pump light (or probe light) and the Stokes light are variable so that the peak power is lower than a reference value even when the laser power is increased compared to the point sweep to maintain the average power per pixel.

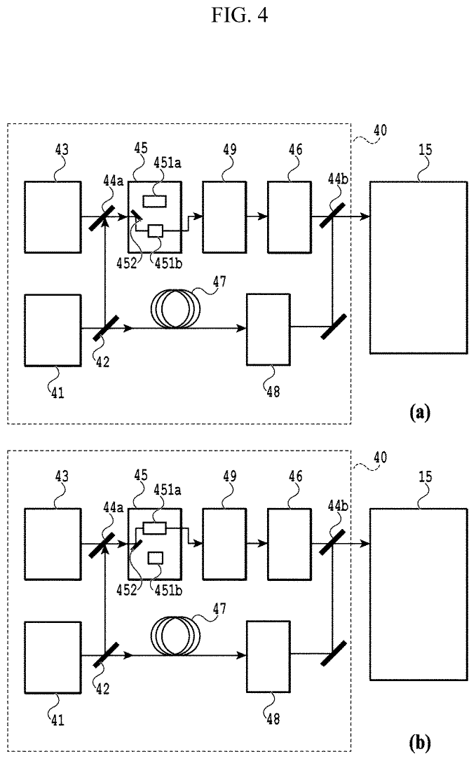

FIG. 4 is a diagram conceptually showing the structure of a light source 40 according to the present disclosure, FIG. 4 (a) shows a form in which input light propagates through a conversion element 451b in a secondary nonlinear optical element 45, and FIG. 4 (b) shows a form in which input light propagates through a conversion element 451a in the secondary nonlinear optical element 45. As shown in FIG. 4, the light source 40 includes a mode-locked laser 41 that outputs a femtosecond pulse laser having a center λₛ; a beam splitter 42 that branches a femtosecond optical pulse train into two systems in terms of power; a continuous wave oscillation (hereinafter referred to as CW) solid-state laser 43 that outputs continuous wave of λₚ; a beam combiner 44a that transmits a continuous wave output from the CW solid-state laser 43, reflects one of the femtosecond optical pulse trains split into two by the beam splitter 42, and outputs a continuous wave having the λₚ and a femtosecond optical pulse train having the center λₛ on the same axis; a secondary nonlinear optical element 45 that converts the femtosecond optical pulse train into a difference frequency generation and conversion optical pulse train with the center λ_{c} consisting of picosecond pulses by generating a difference frequency between continuous wave with the λₚ and the femtosecond optical pulse train with the center λₛ, an amplifier 46 that amplifies the difference frequency generation and conversion optical pulse train; a PM-AND-HNL fiber 47 that converts another femtosecond optical pulse train of center λₛ branched by the beam splitter 42 into supercontinuum light (hereinafter referred to as SC light) having the wavenumber range necessary for the CARS microscope; a dispersion medium 48 that converts the SC optical pulse train into an SC optical pulse train having a pulse width which is approximately the same as the pulse width of the difference frequency generation and conversion optical pulse train output from the amplifier 46; and a beam combiner 44b that multiplexes the optical pulse train output from each of amplifier 46 and dispersion medium 48 and inputs it to the microscope 15.

As shown in FIG. 4, in the light source 40 according to the present disclosure, the secondary nonlinear optical element 45 includes a conversion element 451a and 451b. While the drawing is depicted to include two conversion elements, the conversion elements may be one or more, and in multiple cases, the length of each may be different depending on design. When there is a plurality of conversion elements, the secondary nonlinear optical element 45 may further include a switch mechanism 452 for guiding input light (multiplexing the continuous wave of λₚ and the femtosecond optical pulse train of center λₛ) to a specific conversion element.

As shown in FIG. 4, the light source 40 according to the present disclosure may further include a second dispersion medium 49 which is disposed between the secondary nonlinear optical element 45 and the amplifier 46, and extends the pulse width by applying a chirp to the difference frequency generation and conversion optical pulse train that is output from the secondary nonlinear optical element 45.

In the light source 40 according to the present disclosure, the laser medium of the mode-locked laser 41 may be, for example, Cr⁴⁺: YAG, Cr forsterite, Ti sapphire, Cr: LiSAF, Cr: LiCAF, Cr: ZnSe, Cr: ZnS or the like. In another example, the laser medium of the mode-locked laser 41 may be YAG, YVO₄ or glass (bulk and fiber) added with one rare earth ion selected from Yb, Er, Nd, Tm, and Ho, etc. In another example, the laser medium of the mode-locked laser 41 may be a semiconductor crystal.

In the light source 40 according to the present disclosure, the shape of the gain medium constituting the mode-locked laser 41 may be a rod, a disk, or a fiber.

In the light source 40 according to the present disclosure, a beam splitter 42 may be a half mirror or a beam splitter cube that separates power of input light into two, reflects one thereof, and transmits the other.

In the light source 40 according to the present disclosure, the CW solid-state laser 43 may be a glass fiber laser, a bulk-shaped single-crystal laser, a bulk-shaped ceramic laser, a waveguide-type single-crystal laser, a waveguide-type ceramic laser, or a semiconductor laser.

In the light source 40 according to the present disclosure, the beam combiners 44a and 44b may be dichroic mirrors that reflect light of a predetermined and transmit light of other wavelengths.

In the light source 40 according to the present disclosure, the conversion element included in the secondary nonlinear optical element 45 may be a periodically poled lithium niobate (hereinafter referred to as PPLN), a periodically poled lithium tantalate (hereinafter referred to as PPLT), or a periodically poled KTP (KaTiOPO₄) crystal that satisfies (Equation 5) to be described below.

In the light source 40 according to this embodiment, the amplifier 46 may be a glass fiber amplifier added with one rare earth ion selected from Yb, Er, Nd, Tm, Ho, etc., or a single crystal fiber amplifier in which one rare earth ion selected from Yb, Er, Nd, Tm, Ho, or the like is added to a part of the amplifier.

In the light source 40 having such a configuration, two kinds of optical pulse trains of the difference frequency generation and conversion optical pulse train amplified by the amplifier 46 and the SC optical pulse train output from the dispersion medium 48 are output in a multiplexed state, and are input to the microscope 15. Then, the light obtained by multiplexing the two kinds of optical pulse trains is made incident on the sample as incident light by the microscope 15, and the CARS measurement is performed. In the light source 40 according to the present disclosure, the difference frequency generation and conversion optical pulse train corresponds to pump light (or probe light), and the SC optical pulse train corresponds to Stokes light λₛ and λₚ are selected such that λ_{c} is a pump light (or probe light) and SC light is a Stokes light, so that the necessary CARS measurement is possible.

As can be understood from the above content, in the light source 40 according to the present disclosure, the pulse width is made variable in the selection of the nonlinear optical element or the dispersion medium for the pump light (or probe light) and the selection of the dispersion medium for the Stokes light, respectively. Therefore, in the CARS measurement, the CARS signal intensity reduction more than necessary can be prevented, while suppressing the damage of the sample. This has a great effect especially when a sample such as a biological tissue which is important to suppress damage during observation is measured with high accuracy.

Embodiments of the light source according to the present disclosure is described in detail below using specific examples. In the description of this embodiment, as an example, the light source is set as a light source for observing a region of 400 cm⁻¹ to 4000 cm⁻¹ in wave number spectrum in CARS spectroscopy of the multi-modal nonlinear optical microscope. The mode-locked laser is set as a mode-locked laser oscillator using a Cr⁴⁺: YAG laser as a laser medium, the conversion element of the secondary nonlinear optical element is set as PPLN, the amplifier is set as a Yb-doped glass fiber amplifier (hereinafter, referred to as YbFA), and the CW solid-state laser is set as Yb: YLF laser oscillator that oscillates at a single of 0.607 μm. The Cr⁴⁺: YAG laser used as the mode-locked laser is a femtosecond pulse laser with a center of 1.42 μm, a pulse width of 100 fs, and a repetition frequency of 80 MHz (for example, see NPL 6). Further, a CW solid-state laser is an oscillator of CW light having a single of 0.607 μm.

As described above, in the light source according to the present disclosure, the femtosecond optical pulse train output from the mode-locked laser is branched into two by the beam splitter. One of the two-branched femtosecond optical pulse trains is input to the PPLN as signal light for generating difference frequency generation with a picosecond optical pulse train that is output from the CW solid-state laser. On the other hand, CW light that is output from the CW solid-state laser is input to the PPLN as excited light for generating a difference frequency.

In such a case, an extraordinary ray refractive index of the PPLN used is calculated by (Equation 5), whereλ(μm) is the (see, for example, reference 7)

$$\begin{matrix}[ Math . 5 ] & \\ {n}_{e} ( λ ) = \sqrt{5.3108 + \frac{0.095628}{{λ}^{2} - {0.2068}^{2}} + \frac{100}{{λ}^{2} - {11.34927}^{2}} - 0.01549 {λ}^{2}} & ( Equation 5 )\end{matrix}$$

When a picosecond optical pulse train is generated by difference frequency generation using the CW light as excited light and the femtosecond optical pulse train as signal light, the length of the usable PPLN is limited by a difference in group velocity caused by a difference in between both optical pulse trains in the PPLN. A length L_{τ}used of the PPLN can be obtained by using Equation 6 with reference to the way of obtaining the usable length L_{τ}in the case of SHG (see, for example, NPL 8).

$$\begin{matrix}[ Math . 6 ] & \\ {L}_{τ} = \frac{1.125 {τ}_{c}}{\vert \frac{1}{{v}_{gs}} - \frac{1}{{v}_{gc}} \vert} & ( Equation 6 )\end{matrix}$$

Here, τ_{c} is a pulse width (full width at half maximum) of the converted light (difference frequency generation and conversion light pulse train), V_{gc} is a group velocity of the converted light, and V_{gs} is a group velocity of the signal light.

On the other hand, the of each of the converted light, the signal light, and the excited light satisfies a relationship (Equation 7).

$$\begin{matrix}[ Math . 7 ] & \\ \frac{1}{{λ}_{c}} = \frac{1}{{λ}_{p}} - \frac{1}{{λ}_{s}} & ( Equation 7 )\end{matrix}$$

Here, λ_{c}, λₛ, and λ_{c}represent of each of converted light, the signal light and the excited light.

From (Equation 6) and (Equation 7), in this example, since the of the signal light is 1.42 μm, the of the converted light is 1.06 μm, the pulse width of the converted light caused by the difference in group velocity of the two lights within the PPLN is 2.5 ps, and L_{τ}is calculated as 0.03 m.

Further, to maximize the conversion efficiency of PPLN, it is required to satisfy the phase matching condition represented by Equation (8) with respect to the inversion period Λ (see, for example, NPL 9).

$$\begin{matrix}[ Math . 8 ] & \\ \frac{1}{Λ} = \frac{{n}_{e} ( {λ}_{p} )}{{λ}_{p}} - \frac{{n}_{e} ( {λ}_{s} )}{{λ}_{s}} - \frac{{n}_{e} ( {λ}_{c} )}{{λ}_{c}} & ( Equation 8 )\end{matrix}$$

Further, the efficiency η (%/W) of the difference frequency generation is obtained by (Equation 9), if the powers of the converted light, signal light, and excited light are P_{c}, Pₛ, and Pₚ(W).

$$\begin{matrix}[ Math . 9 ] & \\ η = \frac{100 {P}_{c}}{{P}_{s} {P}_{p}} & ( Equation 9 )\end{matrix}$$

As described above, the efficiency η (%/W) of the generation of the difference frequency when Equation (7) is satisfied can be expressed by Equation (10).

$$\begin{matrix}[ Math . 10 ] & \\ η = {C}_{LN} \frac{{L}^{2}}{{n}_{e} ( {λ}_{c} ) {n}_{e} ( {λ}_{s} ) {n}_{e} ( {λ}_{p} ) {{λ}_{c}}^{2} {A}_{eff}} & ( Equation 10 )\end{matrix}$$

Here, C_{LN} is a constant to PPLN, L is a length (m) of PPLN, and A_{eff} is a beam cross-sectional area (μm²) in PPLN of the excited light and the signal light. In existing reports, it is reported that when λ_{c}=2.3 μm, λₛ=1.58 μm, λₚ=0.937 μm, L=0.05 m, A_{eff}=8.6×13 μm², the efficiency η of difference frequency generation is 100%/W (gor example, see NPL 9). When these numerical values are used, C_{LN} is calculated as 2.28×108.

13 Docket No. 14321.422

In this embodiment, the length of the first PPLN is 0.030 m calculated as above. In this case, when generating a difference frequency in PPLN, a 2.5 ps pulse is generated due to the difference in group velocity between the signal light and the converted light mentioned above.

The of the converted light 1.06 μm is included in the gain band of YbFA that constitutes the amplifier. By using an amplifier as a combination of multiple (for example, two or three) YbFAs, since a gain of about 60 dB can be obtained, an amplified picosecond optical pulse train with a pulse width of 2.5 ps synchronized with the Cr⁴⁺: YAG mode-locked laser is output from the amplifier.

Here, the secondary nonlinear optical element further includes a second PPLN with L_{τ}=0.060 m and a switch mechanism for switching optical paths of two types of lengths. When an optical path is switched to a second PPLN of 0.060 m, an optical pulse train of a pulse width of 5 ps is output as a difference frequency generation and conversion light.

Further, when a dispersion medium is included between the secondary nonlinear optical element and the amplifier, each pulse of the difference frequency generation and conversion optical pulse train is chirped, and the pulse width can be extended to 10 ps or 20 ps and passed. When it is not necessary to apply chirp, the optical path may be switched so that the difference frequency generation and conversion optical pulse train does not pass through the dispersion medium. The dispersion medium is made up of at least one of an optical fiber, a dispersion compensation mirror, a prism pair, and the like. In the case of an optical fiber, two kinds of different lengths or specifications can be selected, in the case of a dispersion compensation mirror, the number of bounce can be changed, and in the case of a prism pair, the position can be changed.

One of the femtosecond optical pulse trains output from the mode-locked laser, which is branched into two, is converted into an SC optical pulse train by a PM-AND-HNL fiber. As in the existing report, it is known that when a pedestal-free clean femtosecond optical pulse is coupled to the PM-AND-HNL fiber, an SC optical pulse with a good SN ratio without a peak in the spectrum is obtained (e.g., NPLs 10 and 11). SC light from all normal dispersion fibers improves SN of a CARS microscope compared to SC light generation using anomalous dispersion fibers or fibers including zero dispersion, and high resolution and high-speed measurement are realized.

For example, an existing report introduces a simulation of SC light generated by the PM-AND-HNL fiber (for example, see NPL 11), and SC light ranging from approximately 0.8 μm to 1. 4μm is generated for a pump light of 1.04 μm.

14 Docket No. 14321.422

This corresponds to a band of approximately 5000 cm⁻¹. When the center of the SC light band and the pump light match, and the band is 5000 cm⁻¹, if the of the pump light (or probe light) is 1.06 μm, the center λₛ of the pump light pulse for SC light generation should be set in the range from 1.26 μm to 1.53 μm. In this embodiment, λₛ is 1.42 μm, which is an appropriate value.

The SC optical pulse train that is output from the PM-AND-HNL fiber passes through the dispersion medium, and is adjusted to a pulse width nearly equal to that of the picosecond pulse train. To synchronize the picosecond pulse train with the femtosecond optical pulse train, the other optical path length of the femtosecond optical pulse train branched into two or the optical path length of the picosecond pulse train may be adjusted between the beam splitter and the microscope.

The light source of this embodiment may be used for spectroscopic measurement and spectroscopic microscope measurement by coherent Raman scattering (for example, induced Raman gain, induced Raman loss, etc.) other than the CARS measurement microscope. Further, SHG and THG may be measured together with the CARS signal and used as a multi-modal nonlinear optical microscope.

### Industrial Applicability

As described above, in the light source according to the present disclosure, the pulse widths of the pump light (or probe light) and the Stokes light are variable, and the average power per pixel can be maintained, accordingly. The center of the femtosecond optical pulse and the of the CW laser for generating the difference frequency are properly selected so that SC light output from the PM-AND-HNL fiber is set in a region required for the CARS measurement. Therefore, as a technique of analysis and observation using Raman scattering spectroscopy having high robustness for the kind of a sample (especially, a sample of biological tissue), application in the medical and industrial fields is expected.

1. A light source for Raman scattering spectroscopy comprising:
a mode-locked laser that outputs a femtosecond optical pulse train of a center λₛ;
a beam splitter that branches the femtosecond optical pulse train into two systems of a first femtosecond optical pulse train and a second femtosecond optical pulse train, in terms of power;
a continuous wave oscillation solid-state laser that outputs continuous wave;
a first beam combiner that transmits the continuous wave output from the continuous wave oscillation solid-state laser, reflects the first femtosecond optical pulse train, and outputs the continuous wave and the first femtosecond optical pulse train on the same axis;
a secondary nonlinear optical element that includes at least one conversion element for outputting a difference frequency generation and conversion optical pulse train including a picosecond optical pulses of a center λ_{c}, by generating a difference frequency between the continuous wave and the first femtosecond optical pulse train;
an amplifier that amplifies the difference frequency generation and conversion optical pulse train;
a polarization-maintaining all normal dispersion high nonlinear fiber that converts the second femtosecond optical pulse train into a supercontinuum optical pulse train;
a first dispersion medium that converts the supercontinuum light pulse train into a pulse width that is approximately the same as a pulse width of the difference frequency generation and conversion optical pulse train output from the amplifier; and
a second beam combiner that multiplexes and outputs the difference frequency generation and conversion optical pulse train output from the amplifier and the supercontinuum optical pulse train output from the first dispersion medium,
wherein a center λₛ and a center λ_{c} are set so that coherent anti-Stokes Raman scattering measurement is performed by the difference frequency generation and conversion optical pulse train and the supercontinuum optical pulse train output from the amplifier.

2. The light source according to claim 1, wherein the secondary nonlinear optical element further comprises:
a plurality of the conversion elements having different lengths; and,
a switch mechanism that is installed on an input side of the plurality of conversion elements to guide input light to a specific conversion element.

3. The light source according to claim 1, further comprising:
a second dispersion medium that is disposed between the secondary nonlinear optical element and the amplifier to extend a pulse width, by applying a chirp to the difference frequency generation and conversion optical pulse train that is output from the secondary nonlinear optical element.

4. The light source according to claim 1, wherein the laser medium of the mode-locked laser is one of Cr⁴⁺: YAG, Cr forsterite, Ti sapphire, Cr: LiSAF, Cr: LiCAF, Cr: ZnSe, Cr: ZnS, or YAG, YVO₄ or glass (bulk and fiber) added with one rare earth ion selected from Yb, Er, Nd, Tm, and Ho, or a semiconductor crystal.

5. The light source according to claim 1, wherein a shape of a gain medium constituting the mode-locked laser is any one of a rod, a disk or a fiber.

6. The light source according to claim 1, wherein the amplifier is one of a glass fiber amplifier added with one rare earth ion selected from Yb, Er, Nd, Tm, Ho, etc., or a single crystal fiber amplifier wherein one rare earth ion selected from Yb, Er, Nd, Tm, Ho, or the like is added to a part.

7. The light source according to claim 1, wherein the continuous wave oscillation solid-state laser is any one of a glass fiber laser, a bulk-shaped single crystal laser, a bulk-shaped ceramic laser, a waveguide-type single crystal laser, a waveguide-type ceramic laser, or a semiconductor laser.

8. The light source according to claim 1, wherein the conversion element included in the secondary nonlinear optical element is any one of a periodically poled lithium niobate, a periodically poled lithium tantalate, and a periodically poled KTP crystal.
